(19) United States
(12) Patent Application Publication
(10) Pub. No.: US 2019/0311424 A1
(43) Pub. Date: Oct. 10, 2019

(54) Product visualization system and method for using two-dimensional images to interactively display photorealistic representations of three-dimensional objects based on smart tagging

(71) Applicant: SWATCHBOOK, Inc., Irvine, CA (US)

(72) Inventors: Yazan W. Malkosh, Laguna Niguel, CA (US); Thomas Teger, Orange, CA (US); Sinareet Aye, Laguna Niguel, CA (US)

(21) Appl. No.: 16/375,199

(22) Filed: Apr. 4, 2019

Related U.S. Application Data
(60) Provisional application No. 62/655,045, filed on Apr. 9, 2018.

(51) Int. Cl. G06Q 30/06; G06F 16/58; G06T 7/40; G06T 11/60

(52) U.S. Cl. CPC G06Q 30/0643; G06T 11/60; G06T 7/40; G06F 16/5866

(57) ABSTRACT

A product visualization system includes: a server, including a product storage; and a device, including a processor, non-transitory memory, input/output, product browser, product visualizer can capture, apply and edit two-dimensional images, and apply them to three-dimensional objects via use of a tagging system in order to interactively visualize the image in combination with simulated real-world materials. Also disclosed is a method for product visualization, including capturing an image, applying a smart tag, and visualizing an associated three-dimensional object.

### CROSS-REFERENCE TO RELATED APPLICATIONS

This application claims the benefit of U.S. Provisional Application No. 62/655,045, filed Apr. 9, 2018; which is hereby incorporated herein by reference in its entirety.

### FIELD OF THE INVENTION

The present invention relates generally to the field of three-dimensional presentation of products, and more particularly to methods and systems for presenting digital representations of materials via methods of product visualization.

### BACKGROUND OF THE INVENTION

While photorealistic creation including real-time interaction with 3D objects has been addressed through many applications over the previous several decades, there are still many designers in various industries who remain focused on 2D modelling, and thus design solely in 2D. Designing and modeling objects in 3D is something that is foreign to this type of designers. Therefore, these 2D designers will have to rely on a 3D artist or designer to help create 3D models in order for them to visualize their 2D art in 3D.

As such, considering the foregoing, it may be appreciated that there continues to be a need for novel and improved devices and methods for presenting digital representations of materials via methods of product visualization.

### SUMMARY OF THE INVENTION

The foregoing needs are met, to a great extent, by the present invention, wherein in aspects of this invention, enhancements are provided to the existing model of product visualization.

In an aspect, a product visualization system can include:
a) a product visualization server; and
b) a product visualization device;
such that the product visualization device enables a user to capture a digital representation of a two-dimensional material;
select a smart tag with an associated three-dimensional object from a customizable tagging system; and
visualize the associated three-dimensional object with the digital representation of the physical material sample applied to surfaces of the associated three-dimensional object;
such that the product visual device stores and receives product information, including the customizable tagging system, in a product storage on the product visualization server.

In an aspect, the product visualizer can allow a user to apply a two-dimensional picture that has either been taken using an external camera, the camera of a cell phone, or created using a 2D graphic design application, or has been downloaded from the internet onto a 3D object using a pre-defined material; and move the object interactively in 3D space to understand how the applied picture will look on the selected object.

In a related aspect, the product visualizer can allow the user to further edit the image directly on the object and see the effects in real-time. All changes to the image can be saved as part of a new material. The object itself can be viewed under various lighting conditions to understand how the image and the underlying material behave. The 3D object can then be taken into an AR/VR environment with a single button push. The mapping of the image onto the object happens automatically and does not require any further user interaction.

The selection of the 3D model can be aided by the use of smart-tags which are tags set by the user that have a 3D model directly linked to the tag.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a product visualization system, according to an embodiment of the invention.

FIG. 2 is a schematic diagram illustrating a product visualization device, according to an embodiment of the invention.

FIG. 3 is a schematic diagram illustrating a product visualization server, according to an embodiment of the invention.

FIG. 4A is an illustration of physical material samples of the product visualization system, according to an embodiment of the invention.

FIG. 4B is an illustration of a digital material representation of the product visualization device, according to an embodiment of the invention.

FIG. 4C is an illustration of a three-dimensional digital object of the product visualization device, according to an embodiment of the invention.

FIG. 5 is an illustration of a graphical user interface of the product visualization device, according to an embodiment of the invention.

FIG. 6 is an illustration of a graphical user interface of the product visualization device, according to an embodiment of the invention.

FIG. 7 is an illustration of a graphical user interface of the product visualization device, according to an embodiment of the invention.

FIG. 8 is an illustration of a graphical user interface of the product visualization device, according to an embodiment of the invention.

FIG. 9 is an illustration of a graphical user interface of the product visualization device, according to an embodiment of the invention.

FIG. 10 is an illustration of a graphical user interface of the product visualization device, according to an embodiment of the invention.

FIG. 11 is an illustration of a graphical user interface of the product visualization device, according to an embodiment of the invention.

FIG. 12 is an illustration of a graphical user interface of the product visualization device, according to an embodiment of the invention.

FIG. 13 is an illustration of a graphical user interface of the product visualization device, according to an embodiment of the invention.

FIG. 14 is an illustration of a graphical user interface of the product visualization device, according to an embodiment of the invention.

FIG. 15 is an illustration of a graphical user interface of the product visualization device, according to an embodiment of the invention.

FIG. 16 is an illustration of a graphical user interface of the product visualization device, according to an embodiment of the invention.

FIG. 17 is a flowchart illustrating steps that may be followed, in accordance with one embodiment of a method or process of product visualization.

FIG. 18 is a schematic diagram illustrating a customizable tagging system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

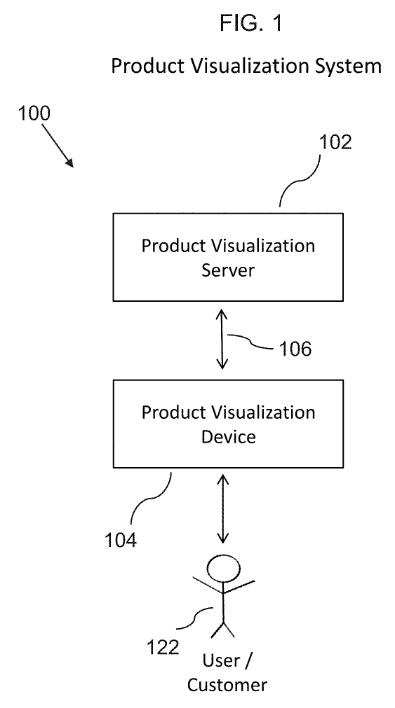

In the following, we describe the structure of an embodiment of a product visualization system 100 for using two-dimensional images to interactively display photorealistic representations of three-dimensional objects based on smart tagging, with reference to FIG. 1, in such manner that like reference numerals refer to like components throughout; a convention that we shall employ for the remainder of this specification.

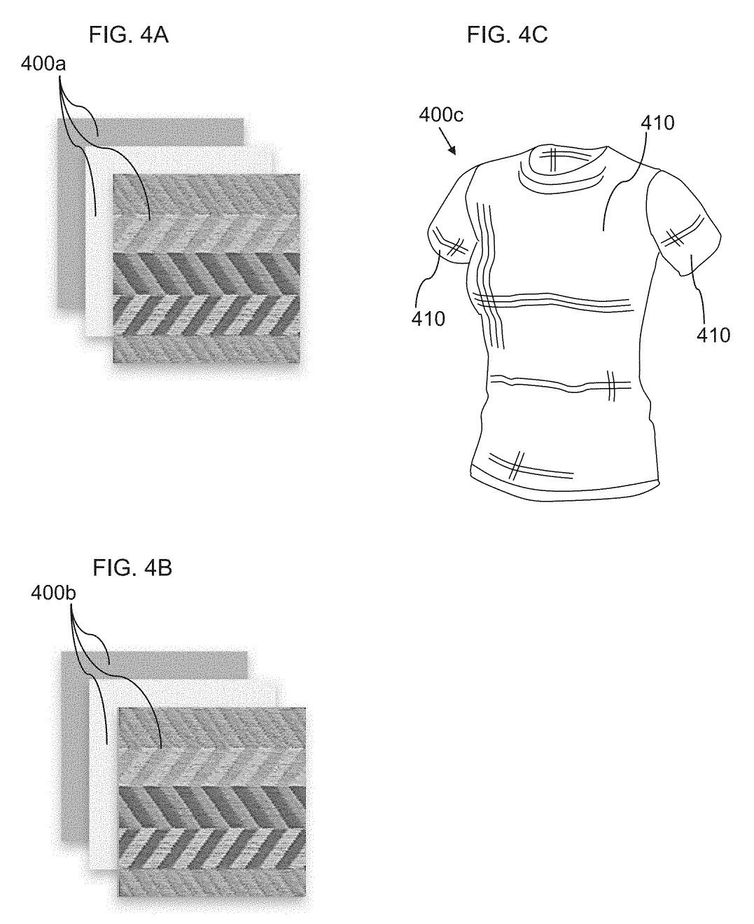

In an embodiment, as shown in FIG. 1, a product visualization system 100 can include:
a product visualization device 104;
wherein the product visualization device 104 can enable a user 122 to capture an image/digital representation 400b of a physical material sample 400a, as shown in FIGS. 4A and 4B;
such that the user 122 is enabled to select a smart tag with an associated three-dimensional object 400c from a customizable tagging system, comprising a hierarchy of tags, such that each tag is associated with a corresponding three-dimensional object 400c;
such that the product visualization device 104 can be configured to show the associated three-dimensional object 400c with the digital representation 400b of the physical material sample 400a applied to surfaces 410 of the associated three-dimensional object 400c;
such that the user 122 can visualize the associated three-dimensional object 400c with the digital representation 400b of the physical material sample 400a applied to surfaces 410 of the associated three-dimensional object 400c.

In a related embodiment, the product visualization system 100 can further include:
a product visualization server 102, such that the product visualization device 104 can be connected to the product visualization server 102;
wherein the product visual device 104 can store and receive product information, including the customizable tagging system, in/from a product storage 310 on the product visualization server 102.

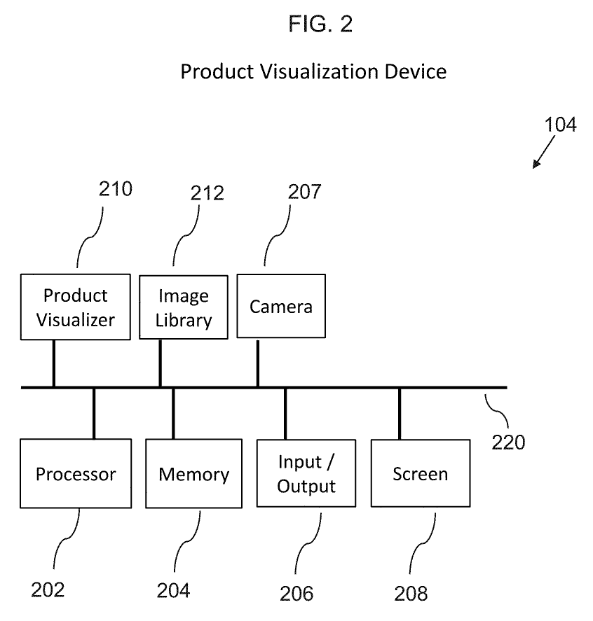

In a related embodiment, as shown in FIG. 2, a product visualization device 104 can include:
a) a processor 202;
b) a non-transitory memory 204;
c) an input/output 206;
d) a camera 207;
e) a screen 208;
f) a product visualizer 210; and
g) an image library 212; all connected via
h) a data bus 220.

In a related embodiment, a product visualization server 102 can include:
a) a processor 302;
b) a non-transitory memory 304;
c) an input/output component 306; and
d) a product storage 310, for storing a customizable tagging system, comprising a hierarchy of tags, such that each tag is associated with a corresponding three-dimensional object; all connected via
e) a data bus 320.

In related embodiments, the product visualization device 104 can include configurations as:
a) a mobile app, executing on a mobile device, such as for example an A ANDROID™ or IPHONE™, or any wearable mobile device;
b) a tablet app, executing on a tablet device, such as for example an ANDROID™ or IOS™ tablet device;
c) a web application, executing in a Web browser;
d) a desktop application, executing on a personal computer, or similar device; or
e) an embedded application, executing on a processing device, such as for example a smart TV, a game console or other system.

It shall be understood that an executing instance of an embodiment of the product visualization system 100, as shown in FIG. 1, can include a plurality of product visualization devices 104, which are each tied to one or more users 122.

An executing instance of an embodiment of the product visualization system 100, as shown in FIG. 1, can similarly include a plurality of product visualization servers 102.

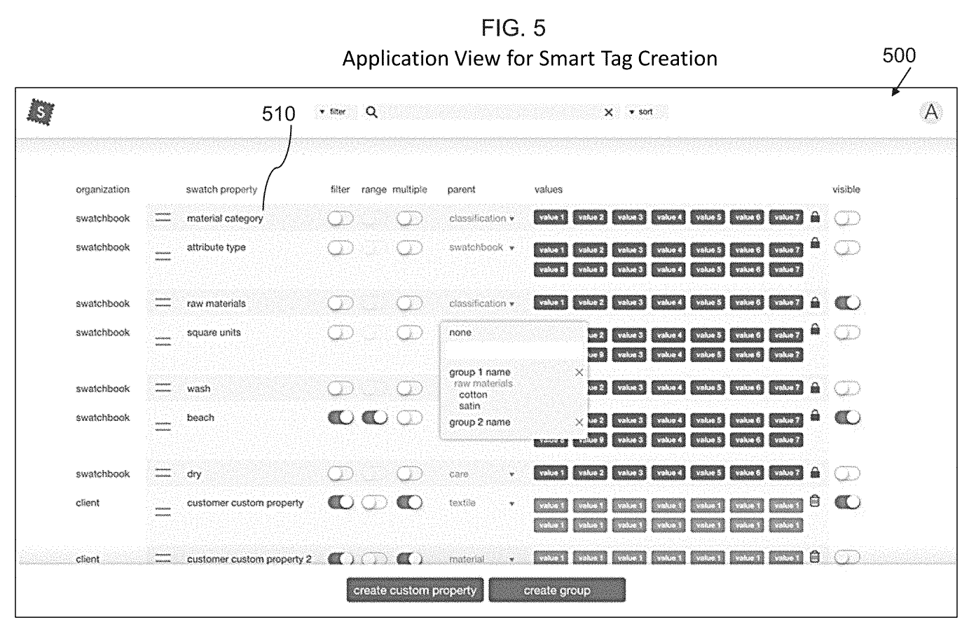

In related embodiments, as shown in FIGS. 5-16 the product visualizer 210 can be configured to allow a user to capture, apply, and edit 2D images that have been captured by a product visualization device 104, and apply the captured images to 3D objects via a tagging system, in order to interactively visualize the image in combination with simulated real-world materials under simulated lighting conditions. The combination of images and digital materials can be saved into an image library 212 for further inspiration, review, refinement, new material development in cooperation with material suppliers. Furthermore, any material stored in the online library can be viewed by simple addition of smart-tags that are associated with 3D models, and associated color ranges of the material can be visualized. Such a product visualization system 100 can also be referred to as a capture-to-manufacture workflow system 100. The functionality provided includes:
a) A tagging system that is fully customizable, allowing users to define and set up context sensitive tags where a tag exposes a relevant collection of sub-tags. The tagging system can have an unbounded depth of sub-tags;
b) Tags that can be associated with a 3D object/model;
c) An application that allows users to visualize 2D images on 3D models through simple tagging;
d) A way of visualizing color ranges of materials on a 3D model;
e) An interactive viewing application for mobile devices; and
f) An interactive view for new material development using mobile devices.

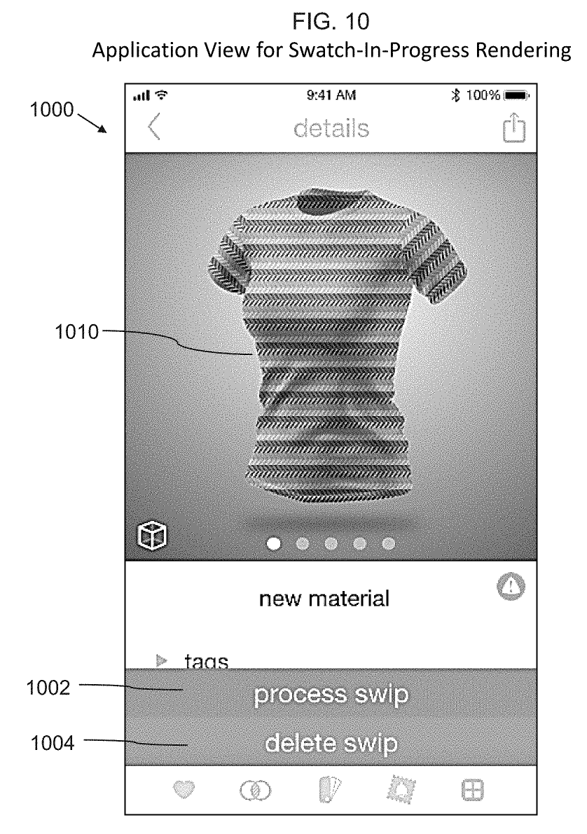

In a related embodiment, the product visualizer 210 of the product visualization device 104 can be configured to overlay a digital material representation 400b of a physical sample 400a onto the digital product model/representation 400c, in order to generate a digital product rendering 1010, as for example shown in FIG. 10, such that the digital product rendering 1010 can be viewed by the user 122. The product visualizer 210 can be configured to generate views with lighting and shadowing, to simulate the appearance of a physical product.

In a related embodiment, as illustrated in FIG. 5, the product visualizer 210 can be configured with an application view for smart tag creation 500, to allow a user to set up smart tags 510 according to a customizable tagging system 1800. The customizable tagging system 1800 allows for creation of tags 1810, 1820, 1822, 1830, 1832, 1834, which are context sensitive, such that the tagging system 1800 allows for defining dependencies of tags, within a tag taxonomy/hierarchy 1800, such that tags 1810, 1822 can be parent tags 1810, 1822, which can be associated with specific sub-tags 1822, 1830, 1832, 1834 that apply to such particular parent tag. A sub-tag 1822, 1830, 1832, 1834 can belong to multiple parent tags 1810, 1822. A sub-tag 1822 in itself can act as a parent tag to other sub-tags 1830, 1832, 1834. The dependencies, referred to as “depth”, can be unbounded, such that a user 122 can set up as many levels of sub-tags as desired. A tagging system or subset of a tagging system can be set up for a manufacturer/make, and its associated brands, and models. A master/parent tag hierarchy 1800 for a particular brand, can for example have a footwear subtag 1810, which has the further subtags 1820, 1822 (not all shown) for athletic men, athletic women, casual men, casual women, formal men, formal woman, each of which has an associated set of model subtags 1830, 1832, 1834; such that each tag 1810, 1820, 1822, 1830, 1832, 1834 is associated with a corresponding 3D object/model 1811, 1821, 1823, 1831, 1833, 1835.

In a related embodiment, a smart tag 1810, 1820, 1831, 1832, 1833 can be associated with a
a) numerical value;
b) numerical range;
c) text descriptor; and/or
d) a 3D object shape representation.

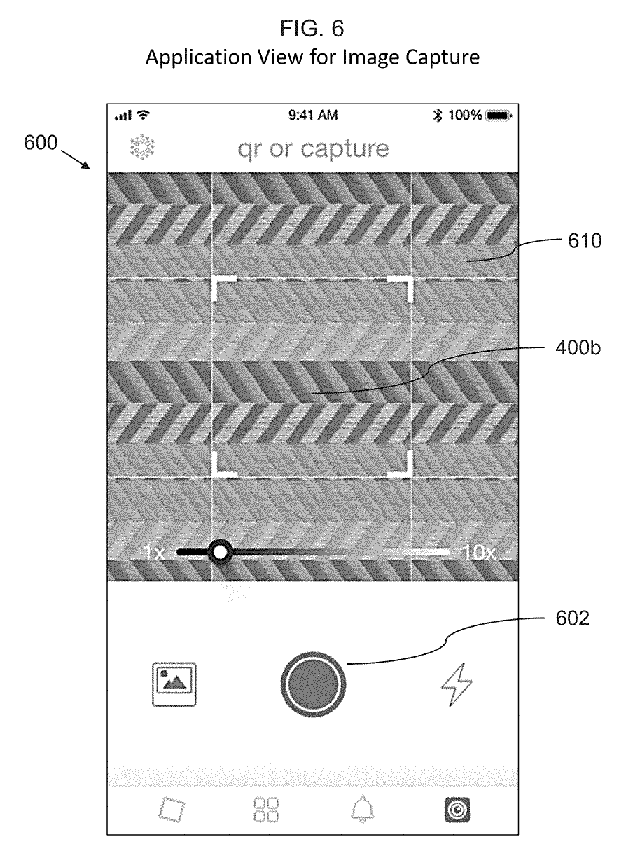

In another related embodiment, as illustrated in FIG. 6, the product visualizer 210 (as shown in FIG. 2) can be configured to capture an image 400b, such that the image 400b can be mapped on to a 3D object shape representation 400c.

In a related embodiment, the 3D object 400c may define/include separate material surfaces/regions 410 of the 3D object 400c, which can represent separate fabric cuts, or areas to which the material representation 400b can be applied. For a shoe, for example, certain surfaces 410 may have a material representation 400b, such as fabric or leather applied, while other areas, such as the sole may not have the material representation 400b applied.

In another related embodiment, the product visualizer 210 can be configured to use the camera 207 of the product visualization device 104 to allow the user to take a picture of any object or surface, using lens zoom and flash if needed. Pressing the capture button 602 processes an image capture. Alternatively, the user can access an image stored in an image library 212 of the of the product visualization device 104. This image can be sourced anywhere, including from applications used for designing and defining 2D graphics. When such an image is selected, the capturing process is com pleted.

In a further related embodiment, the graphical user interface 600 shows a tiled/repeated version 610 of the image 400b, as the captured image 400b may only represent a small part of the material, and as such can be repeated multiple times across an object's surface to define the material surface of the object.

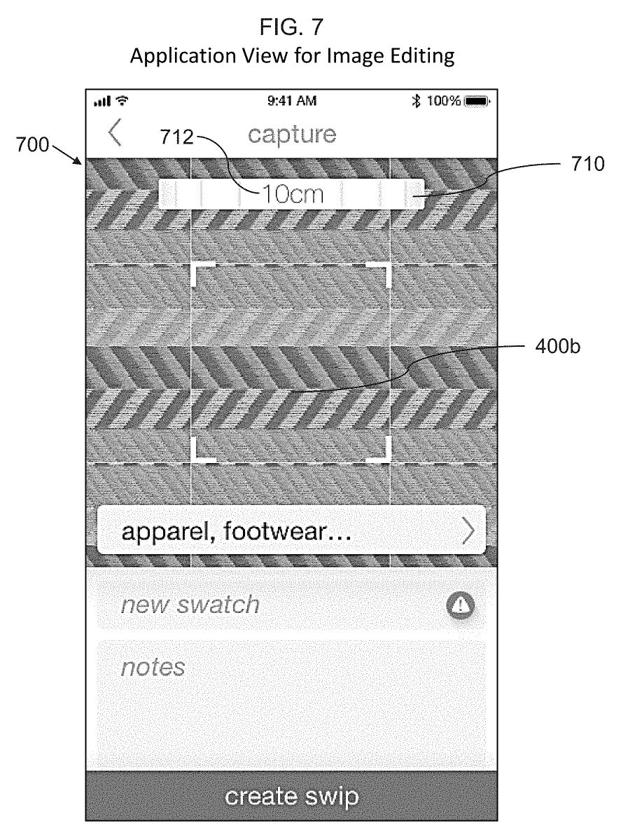

In another related embodiment, as illustrated in FIG. 7, the product visualizer 210 can be configured to allow editing of the captured image 400b. Upon completion of the capturing process, the application automatically advances the user to the next step in the process which is editing the image. FIG. 7 shows the graphical user interface 700 used to further refine the captured image 400b. Using touch input, the user can zoom and pan the image 400b to obtain a tileable pattern of his/her liking.

In a further related embodiment, a ruler 710 above the image 400b can allow a user to slide the numbers left to right to define the desired size of the captured image 400b. An additional click into the active number field 712 can allow the user to type in a numerical value to define the size of the captured image. While there is no visual change of the material, the product visualizer 210 can be configured to pattern the image according to the overall size of the object. This can for example be used to determine how patterns of the material representation 400b is laid out across separate material surfaces/regions 410.

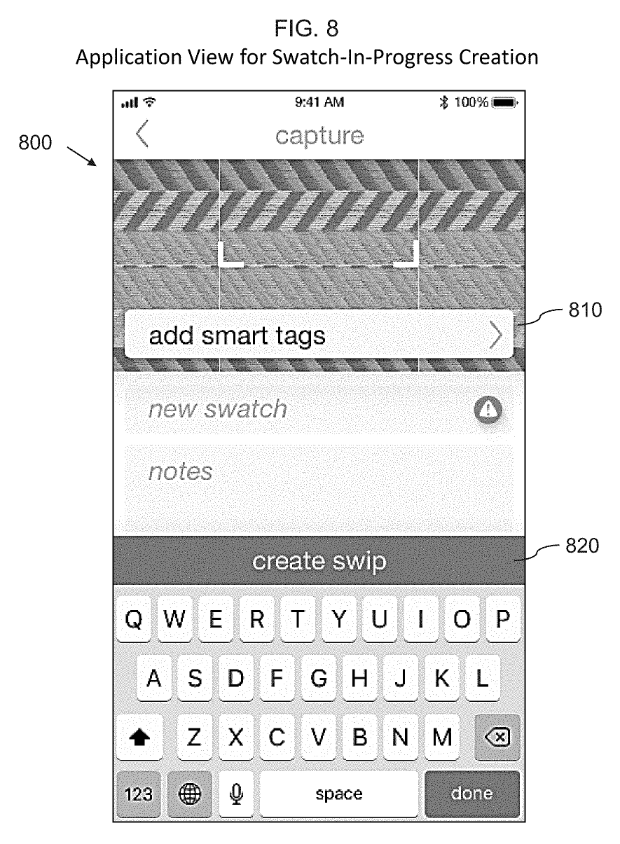

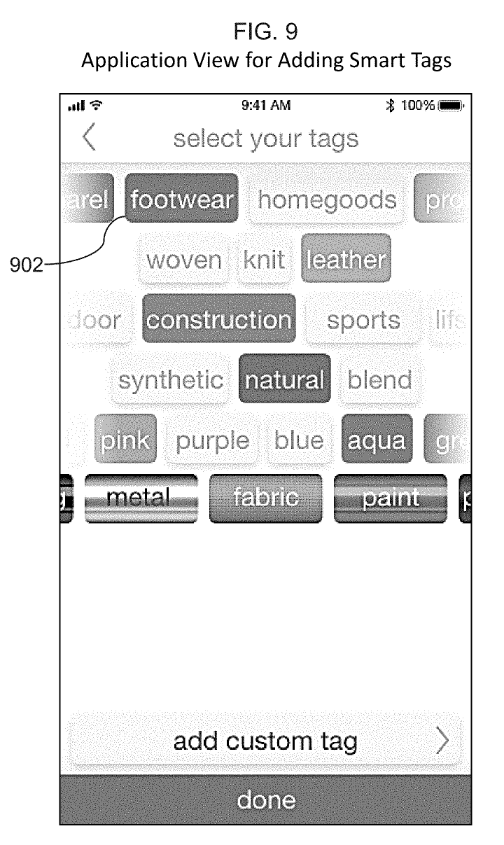

In another related embodiment, as illustrated in FIG. 8, the product visualizer 210 can be configured to allow a user 122 to set up smart tags, in order to complete setup of the new material, which can also be referred to as a material work product or a swatch-in-progress (SWIP). When clicking on add smart tags button 810, the user 122 will be taking to the graphical user interface shown in FIG. 9, which shows the smart tag system set up in FIG. 5. Based on selection of tags 902 starting at the top, the user 122 will be presented with the relevant sub-tags of the selected parent tag. The user can select as many tags 902 as desired.

In yet a related embodiment, as shown in FIG. 9, the tags 902 in the top row can define how the material will be classified, i.e. in what classification it will be used (apparel, footwear etc.). It is up to the user how many sub-tags will be selected. Tags can always be added later through the material edit dialog.

In yet a related embodiment, FIG. 8 shows the ability to add a name for the newly defined material (swip). A name input can be mandatory, and can contain any combination of letters and numbers, combined in individual strings. Notes are optional and can contain any additional notes the user wants to attach to the newly defined material.

In a further related embodiment, as shown in FIG. 8, when tags and name are defined, the create swip button 820 can turn blue (or be otherwise highlighted), which denotes that the user can now create a new material, also called a swatch in progress (swip). This material can be stored in the image library 212, and can be marked as a swip (swatch in progress) using a custom icon. This swip, while present in the image library 212, may only be visible to the individual who created it, not unless their user license allows them to see all swips. Swips can be shared with others in the organization, as well as outside the organization (i.e. with suppliers, etc.).

In a related embodiment, as shown in FIG. 10, the product visualizer 210 can be configured to, upon creation of the swip, guide the user 122 to a detail page 1000. Other alternative embodiments can guide the user straight to a 3D view of the swip. The detail page 1000 contains all information the user has added up to this point, including the image 400b captured in FIG. 6, smart-tags, name and notes.

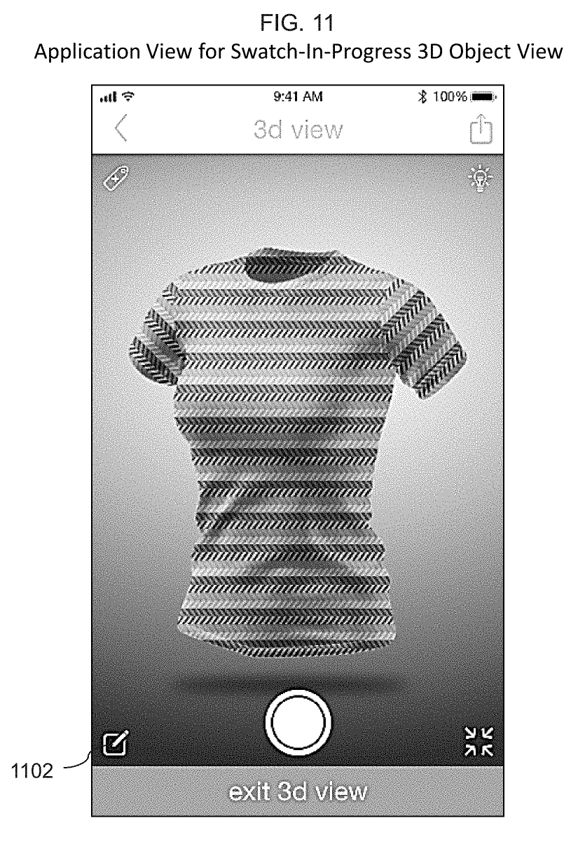

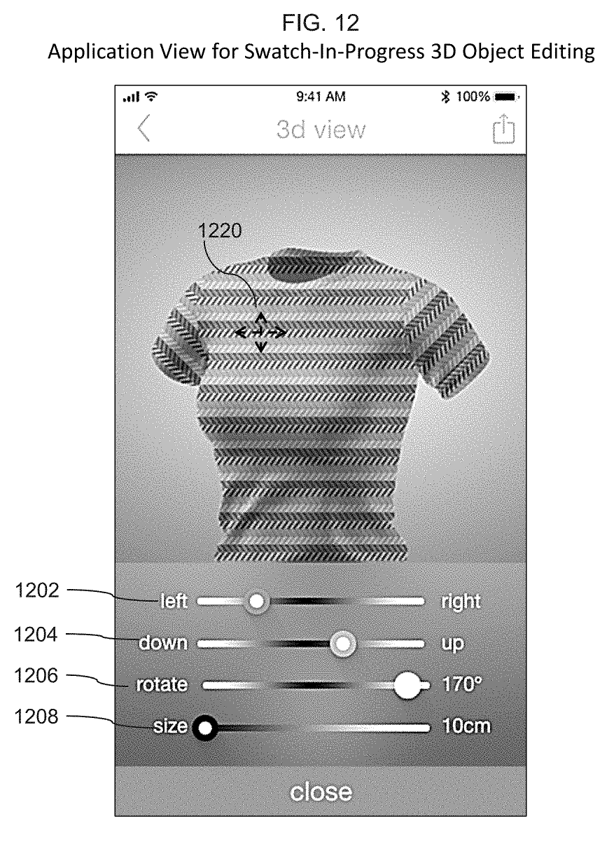

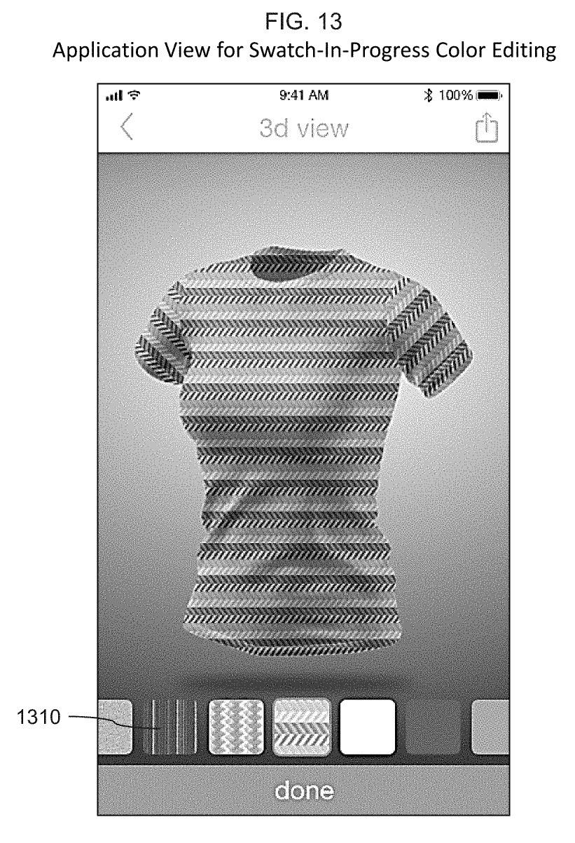

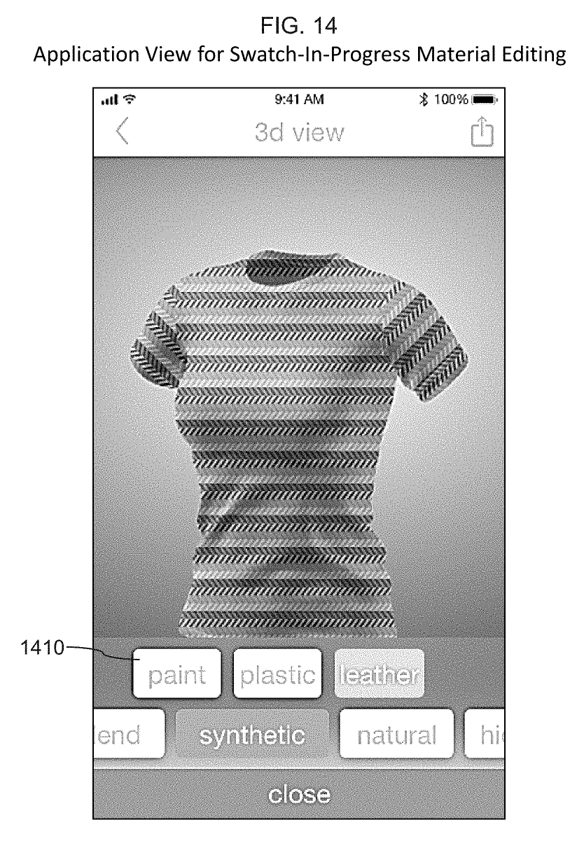

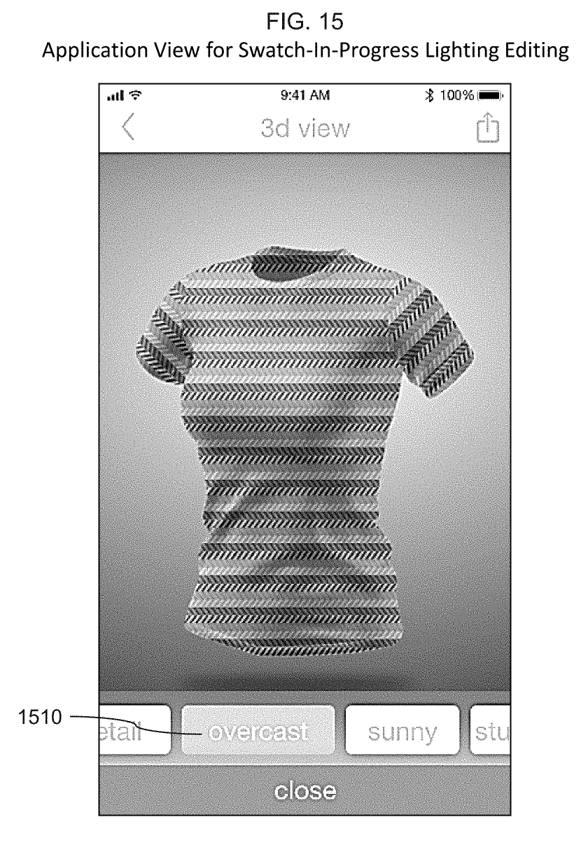

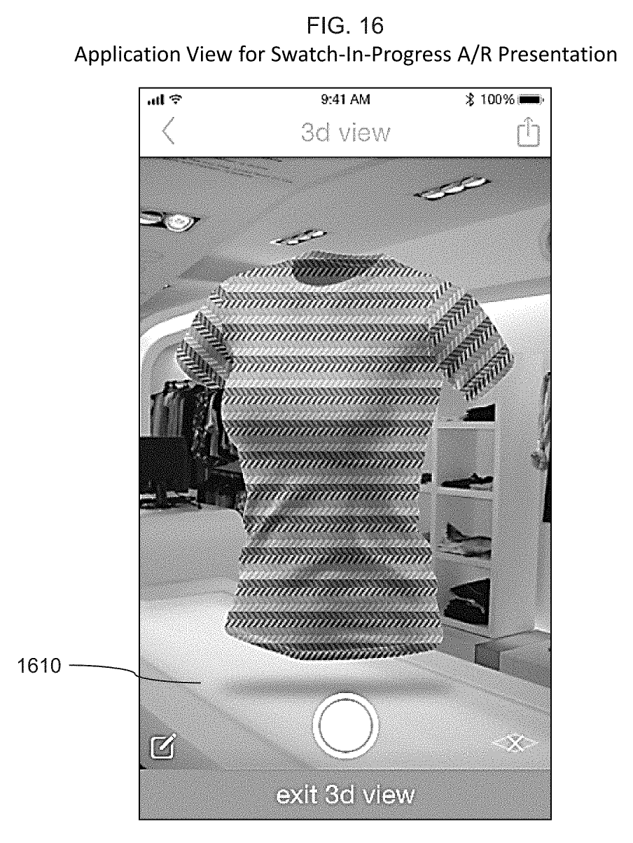

In a further related embodiment, based on the selection of the classification tags, the product visualizer 210 can be configured to create corresponding 3D scenes. The user 122 can access the generated content by swiping from left to right. When swiping to the left the user will get access to the 3D scenes, which can include:
a) Process swip: As shown in FIG. 10, the user 122 can be provided the option to process a swip. Once the swip is processed the process swip button 1002 will go away, and only a delete swip button 1004 will be available along with the other details of the page. Processing a swip will send the current image to the server for processing visual representations for the captured image. This includes drape, roll and 1:1 display. Once finished, these visuals will be available as part of the material's detail page. If the user makes changes to the image on the model as described below, the process swip button will become available again;
b) Delete swip: This function removes all content for the current swatch in progress;
c) View in 3D: As shown in FIG. 11, the swip/material selected in the detail page can be shown in 3D using the object attached to the smart tag that was selected in FIG. 9. If a material has been selected using smart tags in FIG. 9, then this material will be used as well in combination with the image captured with the image capture function shown in FIG. 6. The 3D rendering can be illuminated with default lighting, showing the effect of the lighting on the object;
Furthermore, the material selected can also impact how the lighting reacts based on the material's parameters, based on a material property simulation provided by the product visualizer 210.
The user 122 can interact with the scene by moving a virtual camera (i.e. an internal point-of-view representation) that is being used to visualize the object. Using touch input the user can move the virtual camera around the object (tumble), pan the virtual camera, and move the virtual camera closer and further away from the object (dolly).
In order to view a different 3D object the user will have to click on “exit 3D view” which will close the viewing session and put the user back to the detail page shown in FIG. 10. If additional 3D scenes have been defined through smart tags as shown in FIG. 9, the user can swipe to the left or right to access those scenes.
Additional scenes can have a different 3D object (such as a shirt, cap, shoe, etc.) based on the selected smart tag, but will use the same image captured/defined during image capture and edit, as shown in FIGS. 13 and 14;
d) Edit image on object: As shown in FIG. 12, the product visualizer 210 can be configured to enable the user 122 to edit the object rendered with the captured image by using a set of editing sliders 1202 1204 1206 1208, which let the user update the image mapped to the object in real-time. This function can be accessed by pressing the edit icon 1102, as shown in FIG. 11.
The sliders/selectors 1202 1204 1206 1208 can allow the user to move the image up and down on the object, left and right on the object, rotate the image on the object, and change the scale of the image.
The image scale is carried over from the image editing process shown in FIG. 14. The user can change the size of the image by moving the slider left (smaller) or right (larger). The range can be from one to 10 cm, using single decimal increments. Alternatively, the user can click on the value on the right side of the slider and type in a number that can be larger than 10 cm. The slider will be moved all the way to the left if this is the case. Adjusting the size with the slider again will snap the size back to the maximum slider value of 10, and then move down from there when the slider is moved to the left.
All changes made to the image are saved with the material itself and also for all individual 3D objects. When another 3D object is displayed as described above the image mapped to the object will respect the latest changes and be applied accordingly;
e) View color range: As shown in FIG. 13, the product visualizer 210 can be configured to enable the user 122 to create a color range for an existing material or swip. A color range can have the same tags, 3D objects and material properties, but will provide color manipulated versions of the image capture applied to the material and therefore to the 3D object. When opening the 3D view for a material, as shown in FIG. 11, and the mobile application detects a color range for a material—it does not matter whether the original material or one of the materials of the color range is being selected, the user will see all materials 400b in the color range displayed as thumbnails 1310 in bottom of the screen as shown in FIG. 13. The material can be applied to the 3D object immediately upon selection. Making changes to the displayed material on the 3D object as shown in FIG. 13. is still possible, assuming the material is a swip (swatch in progress);
f) Change material: As shown in FIG. 14, the product visualizer 210 can be configured to allow the user to change the underlying material after it has been selected through a smart tag. Clicking on an icon in the 3D view the system will bring up the smart tags 1410 for the material, as shown in FIG. 14. As soon as new tags 1410 are selected, by clicking on the tag button 1410, the new material will be applied to the 3D object without changing the image defined in views/pages shown in FIGS. 6 and 7. This change, just like changes to the image, can be applied to all 3D objects and scenes automatically. Color ranges can also update accordingly;
g) Change lighting: As shown in FIG. 15, the product visualizer 210 can be configured to change the lighting environment for the scene displaying the object. Lighting environments are also tied to smart tags and can be set up in the smart tag system outlined in FIG. 5. Lighting can be selected by clicking on buttons 1510 for tags identifying the lighting environments. Thus, via selection of a new tag the new lighting environment can be selected. Its effect on the scene, the object and the material is instantly visible;
h) Saving an image: As shown in FIG. 11, the product visualizer 210 can be configured to save the current view in an image. The image can be added to the detail page of the swip. There is no limit how many images the user can save as associated to a swip; and/or
i) AR/VR Presentation: As shown in FIG. 16, the product visualizer 210 can be configured to show the object rendered with the captured image in an augmented reality/virtual reality (AR/VR) environment 1610. The AR/VR environment can be accessed by clicking on an icon.
The interaction with the camera can be specific to the AR/VR controls provided by a toolkit/API used to render the AR/VR environment. In AR/VR mode, users will still be able to edit the image on the object, as shown in FIG. 12. The user can save an image from inside the AR/VR environment by pressing the round circle icon on the middle of the screen towards the bottom. The image will be saved as part of the swip details. There is no limit to how many images can be stored with the swip.

In an embodiment, a product visualization system 100 can include:
a) a product visualization device 104;
wherein the product visualization device 104 can be configured to enable a user 122 to
select a first two-dimensional digital representation 400b of a first physical material sample 400a;
such that the user 122 can be enabled to select a smart tag 1810 with an associated three-dimensional object 400c, 1811 from a customizable tagging system 1800;
such that the product visualization device 104 shows the associated three-dimensional object 1811 with the first two-dimensional digital representation 400b of the first physical material sample 400a applied to surfaces 410 of the associated three-dimensional object 400c, 1811.

In a related embodiment, the product visualization device 104 can include a camera 207, such that the product visualization device 104 is configured to enable the user 122 to capture the first two-dimensional digital representation 400b of the first physical material sample 400a with the camera 207.

In another related embodiment, the customizable tagging system 1800 can include a hierarchy of tags, such that each tag 1810, 1820, 1822, 1830, 1832, 1834 in the hierarchy of tags is associated with a corresponding three-dimensional object 1811, 1821, 1823, 1831, 1833, 1835.

In yet a related embodiment, the customizable tagging system 1800 can include a hierarchy of tags, comprising at least one parent tag 1810, 1822, which is associated with a plurality of sub-tags 1822, 1830, 1832, 1834.

In yet another related embodiment, the product visualization device 104 can further include:
a) a processor 202;
b) a non-transitory memory 204;
c) an input/output 206; and
d) a product visualizer 210; all connected via
e) a data bus 220.

In a related embodiment, the product visualization system 100 can further include:
a product visualization server 102, such that the product visualization device is connected to the product visualization server;
wherein the product visual device 104 receives product information, comprising the customizable tagging system 1800, from the product visualization server 102.

In yet a related embodiment, the product visualization server 102 can further include:
a) a processor 302;
b) a non-transitory memory 304;
c) an input/output component 306; and
d) a product storage 310, for storing the customizable tagging system 1800; all connected via
e) a data bus 320.

In yet a related embodiment, the associated three-dimensional object 400c can include a plurality of material surfaces 410, such that the two-dimensional digital representation 400b of the physical material sample 400a is applied solely to the plurality of material surfaces 410.

In a related embodiment, the two-dimensional digital representation 400b of the physical material sample can be repeated in a tiled structure across the surfaces 410 of the associated three-dimensional object 400c.

In a related embodiment, the product visualizer 210 can be configured to adjust a size of the two-dimensional digital representation 400b of the physical material sample relative to the surfaces 410 of the associated three-dimensional object 400c.

In a related embodiment, as shown in FIG. 12, the product visualizer 210 can be configured to adjust a position 1220 of the two-dimensional digital representation 400b of the physical material sample relative to the surfaces 410 of the associated three-dimensional object 400c.

In a related embodiment, the product visualizer 210 can be configured to change the first two-dimensional digital representation 400b, such that the product visualization device shows the associated three-dimensional object 400c with a second two-dimensional digital representation 400b of a second physical material sample 400a applied to surfaces 410 of the associated three-dimensional object 400c.

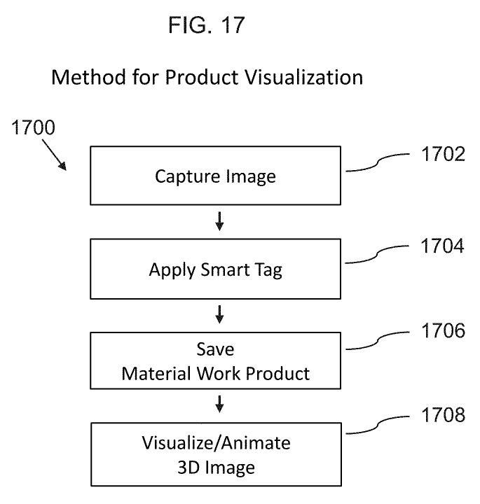

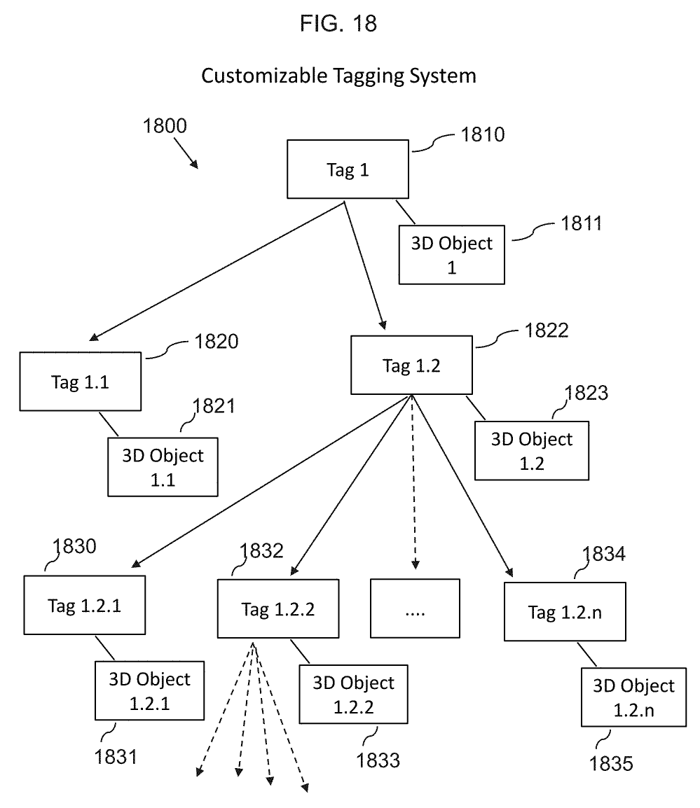

In an embodiment, as illustrated in FIG. 17, a method for product visualization 1700, which can also be referred to as a capture-to-manufacture workflow method 1700, can include:
a) Capturing image 1702, wherein a user 122 captures an image of a material sample using a product visualization device 104;
b) Applying smart tag 1704, wherein the user 122 selects a smart tag from a customizable tagging system, such that the smart tag is associated with the image, wherein the smart tag is associated with a 3D object;
c) Saving material work product 1706, wherein a material work product (also called Swatch-In-Progress or SWIP) is saved, wherein the material work product comprises the image, the smart tag and an associated 3D object, and the selected image applied to a surface of the 3D object; and
d) Visualizing/Animating 3D image 1708, wherein the swatch-in-progress is rendered in an animated 3D view for visual inspection, such that the associated three-dimensional object is rendered with the image applied to surfaces of the three-dimensional object.

In a related embodiment, a method for product visualization 1700 can include:
a) capturing an image 1702, wherein a user captures an image of a material sample using a product visualization device;
b) applying a smart tag 1704, wherein the user selects the smart tag from a customizable tagging system, such that the smart tag is associated with the image, wherein the smart tag is associated with a three-dimensional object; and
c) visualizing the three-dimensional object 1708, wherein the associated three-dimensional object is rendered with the image applied to surfaces of the three-dimensional object.

In a further related embodiment, the method for product visualization 1700 can further include:
saving material work product 1706, wherein a material work product is saved on the product visualization device, wherein the material work product comprises the image, the smart tag and an associated three-dimensional object, and the selected image applied to a surface of the 3D object.

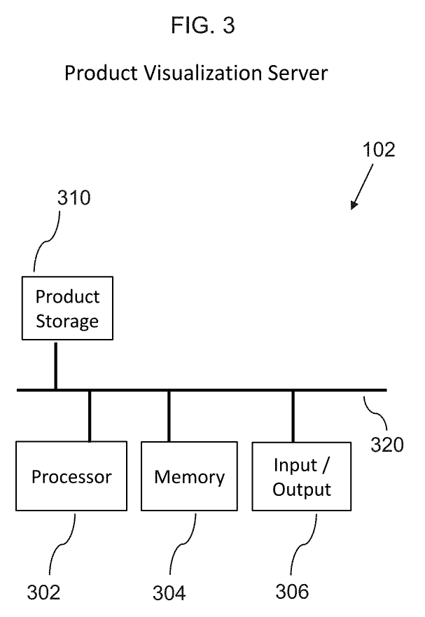

FIGS. 1, 2, 3, and 17 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the product visualization system 100, including the product visualization server 102, and the product visualization device 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the product visualization server 102 and the product visualization device 104 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the product visualization server 102 and the product visualization device 104 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the product visualization device 104 communicates with the product visualization server 102 over a network 106, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the product visualization system 100, the product visualization device 104, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the product visualization server 102 and the product visualization device 104. The components of the product visualization server 102 can be distributed over a plurality of physical, logical, or virtual servers. Parts or all of the components of the product visualization device 104 can be configured to operate in the product visualization server 102, whereby the product visualization device 104 for example can function as a thin client, performing only graphical user interface presentation and input/output functions. Alternatively, parts or all of the components of the product visualization server 102 can be configured to operate in the product visualization device 104.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A product visualization system, comprising:
a product visualization device;
wherein the product visualization device is configured to enable a user to select a first two-dimensional digital representation of a first physical material sample;
such that the user is enabled to select a tag with an associated three-dimensional object from a customizable tagging system;
such that the product visualization device shows the associated three-dimensional object, such that the first two-dimensional digital representation of the first physical material sample is applied to at least one surface of the associated three-dimensional object.

2. The product visualization system of claim 1, wherein the product visualization device comprises a camera, such that the product visualization device is configured to enable the user to capture the first two-dimensional digital representation of the first physical material sample with the camera.

3. The product visualization system of claim 1, wherein the customizable tagging system comprises a hierarchy of tags, such that each tag in the hierarchy of tags is associated with a corresponding three-dimensional object.

4. The product visualization system of claim 1, wherein the customizable tagging system comprises a hierarchy of tags, comprising at least one parent tag, which is associated with a plurality of sub-tags.

5. The product visualization system of claim 1, wherein the product visualization device further comprises:
a) a processor;
b) a non-transitory memory;
c) an input/output; and
d) a product visualizer, which is configured to show the associated three-dimensional object, such that the first two-dimensional digital representation is applied to the at least one surface of the associated three-dimensional object; all connected via
e) a data bus.

6. The product visualization system of claim 1, further comprising:
a product visualization server, such that the product visualization device is connected to the product visualization server;
wherein the product visual device receives product information, comprising the customizable tagging system, from the product visualization server.

7. The product visualization system of claim 6, wherein the product visualization server further comprises:
a) a processor;
b) a non-transitory memory;
c) an input/output component; and
d) a product storage, for storing the customizable tagging system; all connected via
e) a data bus.

8. The product visualization system of claim 1, wherein the associated three-dimensional object comprises a plurality of material surfaces, such that the first two-dimensional digital representation of the first physical material sample is applied solely to the plurality of material surfaces.

9. The product visualization system of claim 1, wherein the first two-dimensional digital representation of the first physical material sample is repeated in a tiled structure across the at least one surface of the associated three-dimensional object.

10. The product visualization system of claim 5, wherein the product visualizer is configured to adjust a size of the first two-dimensional digital representation of the first physical material sample relative to the at least one surface of the associated three-dimensional object.

11. The product visualization system of claim 5, wherein the product visualizer is configured to adjust a position of the first two-dimensional digital representation of the first physical material sample relative to the at least one surface of the associated three-dimensional object.

12. The product visualization system of claim 5, wherein the product visualizer is configured to change the first two-dimensional digital representation, such that the product visualization device shows the associated three-dimensional object with a second two-dimensional digital representation of a second physical material sample applied to the at least one surface of the associated three-dimensional object.

13. A method for product visualization, comprising:
a) capturing a first image, wherein a user captures the first image of a first material sample using a product visualization device;
b) applying a tag, wherein the user selects the tag from a customizable tagging system, such that the tag is associated with the first image, wherein the tag is associated with an associated three-dimensional object; and
c) visualizing the associated three-dimensional object, wherein the associated three-dimensional object is rendered with the first image applied to at least one surface of the associated three-dimensional object.

14. The method for product visualization of claim 13, further comprising:
saving a material work product, wherein the material work product is saved on the product visualization device, wherein the material work product comprises the first image, the tag and the associated three-dimensional object, wherein the first image is applied to the at least one surface of the associated three-dimensional object.

15. The method for product visualization of claim 13, wherein the customizable tagging system comprises a hierarchy of tags, such that each tag in the hierarchy of tags is associated with a corresponding three-dimensional object.

16. The method for product visualization of claim 13, wherein the customizable tagging system comprises a hierarchy of tags, comprising at least one parent tag, which is associated with a plurality of sub-tags.

17. The method for product visualization of claim 13, wherein the associated three-dimensional object comprises a plurality of material surfaces, such that the first material sample is applied solely to the plurality of material surfaces.

18. The method for product visualization of claim 13, wherein the first image is repeated in a tiled structure across the at least one surface of the associated three-dimensional object.

19. The method for product visualization of claim 13, further comprising adjusting a size of the first image relative to the at least one surface of the associated three-dimensional object.

20. The method for product visualization of claim 13, further comprising adjusting a position of the first image relative to the at least one surface of the associated three-dimensional object.

21. The method for product visualization of claim 13, further comprising changing the first image, such that the product visualization device shows the associated three-dimensional object with a second image of a second material sample applied to the at least one surface of the associated three-dimensional object.
